(19) United States
(12) Patent Application Publication
(10) Pub. No.: US 2023/0266984 A1
(43) Pub. Date: Aug. 24, 2023

(54) CONTAINER-BASED OPERATING SYSTEM TRANSLATION

(71) Applicant: Red Hat, Inc., Raleigh, NC (US)

(72) Inventors: Daniel Walsh, Boston, MA (US); Giuseppe Scrivano, Milan (IT); Aditya Rajan, Delhi (IN)

(21) Appl. No.: 17/678,925

(22) Filed: Feb. 23, 2022

(51) Int. Cl. G06F 9/455; G06F 9/4401; G06F 9/54

(52) U.S. Cl. CPC G06F 9/45554; G06F 9/4406; G06F 9/545

(57) ABSTRACT

A container image is received at a host device. The container image includes a container application compatible with a first operating system, and the host device includes a second operating system, different from the first operating system. A container engine on a processing device executes a container corresponding to the container image. The container engine includes an emulator configured to translate a request from the container application that is directed to the first operating system into a request to the second operating system.

### TECHNICAL FIELD

Aspects of the present disclosure relate to containers, and more particularly, to the execution of containers having a non-native operating system.

### BACKGROUND

Containers are active components executing on an operating system that provide an environment for applications to run, while being isolated from any other components of a host machine, network, or data center etc. Multiple containers may execute on a single operating system kernel and share the resources of the hardware the operating system is running on. All of the files, libraries and dependencies necessary to run applications in a container may be provided by an image file(s). An image file may be comprised of a set of base layers that define the runtime environment, as well as the packages and utilities necessary for a containerized application to run. A container may include the base layers from an image file as well as an in-memory layer in which the containerized application may write/modify data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a block diagram that illustrates an example system, according to some embodiments of the present disclosure.

FIGS. 2A and 2B are block diagrams contrasting the use of a virtual machine executing within a computing device and an example container executing within a computing device, according to some embodiments of the present disclosure.

FIG. 3 illustrates an example container image, according to some embodiments of the present disclosure.

FIG. 4 is a schematic diagram of system that provides additional details regarding the container engine, according to some embodiments of the present disclosure.

FIG. 5 is a flow diagram of a method for executing a non-native container image, according to some embodiments of the present disclosure.

FIG. 6 is a block diagram that illustrates an example system, according to some embodiments of the present disclosure.

FIG. 7 is a flow diagram of a method for dynamically executing a non-native container image, according to some embodiments of the present disclosure.

FIG. 8 is a block diagram of an example computing device that may perform one or more of the operations described herein, according to some embodiments of the present disclosure.

### DETAILED DESCRIPTION

Modern computer systems support a broad number of operating systems. Some operating systems may have particular advantages in some environments while having disadvantages in others. For example, some operating systems may include features that perform well in server environments, while other operating systems perform well in client devices. Other examples include operating systems that work well on resource-constrained devices, such as phone or internet-of-things (IoT) devices.

Unfortunately, compatibility between the different operating systems can be problematic. Often, an application designed and/or compiled on one operating system may not be run on another operating system for which it is not native, or may only be capable of running with specialized compatibility measures. As used herein, a “native” application is an application which has been compiled and/or built for the operating system on which it is being executed. As used herein, a “non-native” application is one which has been compiled and/or built for a first operating system, but is to be executed on and/or is compatible with a second operating system that is different from the first operating system. A “different” operating system is one which supports a different executable format, or underlying architecture. In general, an application is considered “non-native” to a particular operating system if it is incompatible with the operating system without compatibility infrastructure to allow the application to execute. Examples of non-compatible operating systems include operating systems having different architectures, different file systems, different operating system types and the like. Non-limiting examples of operating systems which are different from one another include WINDOWS™, LINUX™, and ANDROID™. As used herein, the term “and/or” includes any and all combinations of one or more of the associated listed items.

One mechanism for proving non-native operating system support includes the use of compatibility libraries. For example, a compatibility library may allow a Windows-based application to execute on a Linux operating system. In this example, the Windows-based application would be non-native to Linux. While these compatibility libraries may provide a base level of support, such libraries may require special configuration by an administrator. The ability to provide support for more than one non-native operating system may be hindered by the specialized configurations utilized by each of them. Moreover, when compatibility libraries are used, it can be difficult to isolate that executing programs from one another. For example, when only compatibility libraries are used, multiple non-native application may share a run-time environment and be able to “see” one another. This may limit the ability to control the access and security provided for applications that are executed utilizing these libraries.

Another mechanism that may be used to provide non-native support is the use of virtualization, such as virtual machines (VMs). In virtualization, a virtual processor and memory may be provided and a non-native operating system may be run on these virtual resources. The non-native operating system may then execute the non-native application. While virtualization may provide isolation, it may come at the cost of overhead. The use of virtual machines includes the installation and execution of the entire non-native operating system. This may include the execution of a large amount of infrastructure that is unnecessary for the underlying non-native application. Such a solution also may utilize an otherwise larger memory and storage footprint than would otherwise be required, because memory and storage must be allocated for an entire operating even though only a single application was desired. Also, the execution of the additional overhead of the virtualized operating system may negatively impact the performance of the application. Thus, the mechanisms that might otherwise be used to execute non-native applications on an operating system can introduce security issues, resource issues, and/or performance issues.

The present disclosure addresses the above-noted and other deficiencies by incorporating compatibility infrastructure into a container environment. The compatibility infrastructure may be included in a runtime environment of the container such that the container itself may not need to include any facilitation for the non-native support. By implementing the compatibility infrastructure into the container runtime environment, the container itself may be completely unaware that it is running on a non-native operating system. In some embodiments, the contents of the container may be entirely non-native to the host operating system upon which they are intended to run. For example, the entire container may be configured and/or compatible with a non-native operating system, but may nonetheless be capable of running on the host operating system through the use of the container runtime environment.

Moreover, the use of containers allows for the application of the container to be isolated from other applications running on the system. The container infrastructure may limit the ability of the application within the container from accessing beyond the container environment. The use of containers may also avoid the use of a virtual operating system, such that the non-native operating system is not required as in a VM. This may reduce the amount of memory utilized to run the non-native application, and, in some embodiments, increase performance and resource utilization.

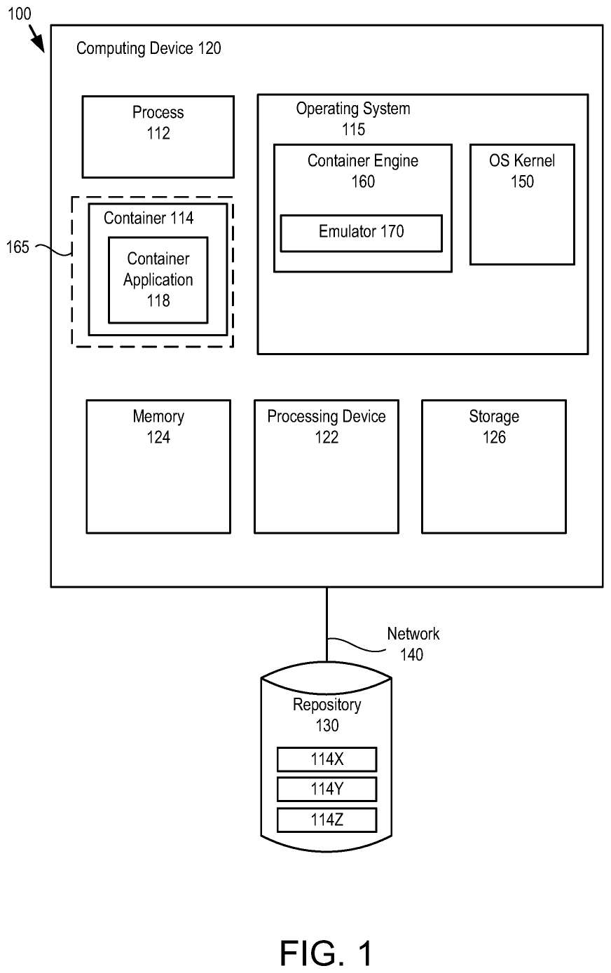

FIG. 1 is a block diagram that illustrates an example system 100, according to some embodiments of the present disclosure. As illustrated in FIG. 1, the system 100 includes a computing device 120 (also referred to herein as host device 120 and host computing device 120), a repository server 130, and a network 140. The computing device 120 and the repository server 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WIFI™ hotspot connected with the network 140 and/or a wireless carrier system that can be implemented using various data processing equipment, communication towers (e.g. cell towers), etc. The network 140 may carry communications (e.g., data, message, packets, frames, etc.) between computing device 120 and repository server 130.

The computing device 120 (and repository server 130) may include hardware such as processing device 122 (e.g., processors, central processing units (CPUs)), memory 124 (e.g., random access memory (RAM), storage devices 126 (e.g., hard-disk drive (HDD)), and solid-state drives (SSD), etc.), and other hardware devices (e.g., sound card, video card, etc.). A storage device 126 may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIG. 1 and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

The computing device 120 and repository server 130 may comprise any suitable type of computing device or machine that has a programmable processor including, for example, server computers, desktop computers, laptop computers, tablet computers, smartphones, set-top boxes, etc. In some examples, the computing device 120 and repository server 130 may comprise a single machine or may include multiple interconnected machines (e.g., multiple servers configured in a cluster). The computing device 120 and repository server 130 may be implemented by a common entity/organization or may be implemented by different entities/organizations. For example, computing device 120 may be operated by a first company/corporation and repository server 130 may be operated by a second company/corporation. The computing device 120 and repository server 130 may each execute or include an operating system (OS), as discussed in more detail below. The operating systems of computing device 120 and repository server 130 may manage the execution of other components (e.g., software, applications, etc.) and/or may manage access to the hardware (e.g., processors, memory, storage devices etc.) of the computing device.

The computing device 120 may execute an operating system 115 (also referred to herein as a “host operating system”). Operating system 115 may be software to provide an interface between the computing hardware (e.g., processing device 122 and/or storage device 126) and applications running on the operating system 115. Operating system 115 may include an OS kernel 150 and a user space supporting the execution of one or more containers 114. Operating system kernel 150 may include several operating system functionalities, including but not limited to process management, hardware interfaces, access control and the like. The OS kernel 150 may execute with an elevated privilege and may manage the administration of the operating system 115. Examples of operating systems 115 include WINDOWS, LINUX, ANDROID, IOS™, and MACOS™.

Repository server 130 may be a server which may store image files (e.g., container images 114X, 114Y, 114Z), as discussed in further detail herein. Although FIG. 1 illustrates only a single computing device 120 for ease of illustration and description, computing device 120 may be just one deployment among many within an overarching cloud or on-premises infrastructure that system 100 represents. For example, additional computing devices may be included within system 100 that act as additional deployments.

As illustrated in FIG. 1, computing device 120 may run a container 114 (also referred to herein as a “container image”). The container 114 may include a container application 118 (also referred to herein as application 118). Container application 118 may be a desktop application, a network application, a database application, or any other application that may execute within the container 114. In some embodiments, the container 114 may execute on a container engine 160 which executes on the processing device 122 within the host OS 115 of computing device 120, as discussed in more detail herein. The container engine 160 may allow different containers 114 to share access to the host OS 115 (e.g., the OS kernel 150, packages, binaries, libraries thereof etc.), and may also perform other functions as discussed in more detail herein. The container 114 may be isolated, in that it is not connected to any other process 112 of system 100, whether virtual or otherwise.

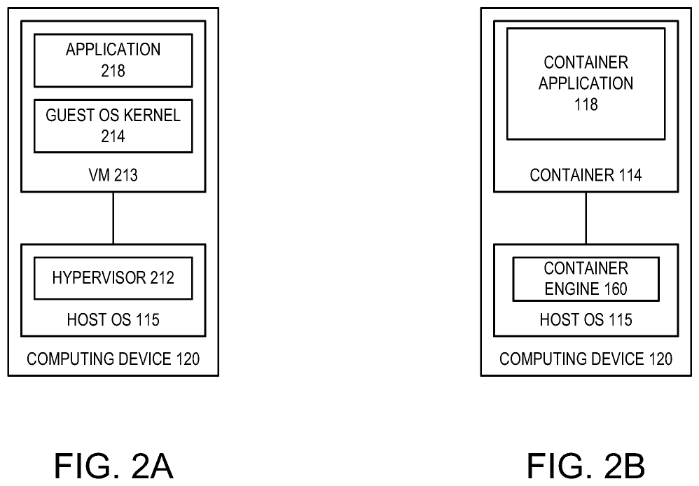

FIG. 2A is a block diagram that illustrates an example virtual machine executing within a computing device, in accordance with some embodiments of the present disclosure. FIG. 2B is a block diagram that illustrates an example container executing within a computing device, in accordance with some embodiments of the present disclosure. FIGS. 2A and 2B contrast the use of a virtual machine with the use of a container such as container 114 of FIG. 1.

Referring to FIG. 2A, in a VM-based infrastructure, a computing device 120 may include hardware (e.g., processing devices, memory, storage devices, other devices, etc.) and a host OS 115. As discussed above, one type of a virtual environment may be a virtual machine (VM) 213 executing on a computing device 120. In one embodiment, the VM 213 may be a software implementation of a machine (e.g., a software implementation of a computing device) that includes its own operating system (referred to as guest OS 214), including its own kernel, and executes application programs, applications, software. VM 213 may be, for example, a hardware emulation, a full virtualization, a para-virtualization, and an operating system-level virtualization VM.

Computing device 120 may include a hypervisor 212, which may also be known as a virtual machine monitor (VMM). In the example shown, hypervisor 212 may be a component of a host operating system 115. In another example, hypervisor 212 may run on top of a host operating system 115, or may run directly on host hardware without the use of a host operating system 115. Hypervisor 212 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 212, though typically implemented in software, may emulate and export a bare machine interface to higher level software in the form of virtual processors and guest memory. Higher level software may comprise a standard or real-time operating system (OS), may be a highly stripped down operating environment with limited operating system functionality, may not include traditional OS facilities, etc. Hypervisor 212 may present other software (i.e., “guest” software) the abstraction of one or more virtual machines (VMs) that provide the same or different abstractions to various guest software (e.g., guest operating system, guest applications).

VM 213 may execute guest software that uses an underlying emulation of the physical resources (e.g., virtual processors and guest memory). As illustrated in FIG. 2A, VM 213 may execute an application 218 within a runtime environment (not shown in the figures).

Referring to FIG. 2B, in a container-based infrastructure, a computing device 120 may include hardware (e.g., processing devices, memory, storage devices, other devices, etc.) and a host OS 115. A container 114 make execute as part of the host OS 115 on the computing device 120. In one embodiment, the container 114 may be an isolated set of resources allocated to executing a container application 118 and may be process independent from other applications, software, and/or processes. The host OS 115 may use namespaces to isolate the resources of the containers 114 from each other. In another embodiment, the container 114 may be a virtualized object similar to virtual machines. However, container 114 may not implement separate guest OS (like the guest OS kernel 214 of the VM 213 illustrated in FIG. 2A). The container 114 may share the kernel, libraries, and binaries of the host OS 115 with other containers 114 that are executing on the computing device 120. Although FIG. 2B illustrates one container 114, the computing device 120 may include multiple containers 114 in other embodiments.

In one embodiment, the container engine 160 may allow different containers 114 to share the host OS 115 (e.g., the OS kernel, binaries, libraries, etc.) of the computing device 120. For example, the container engine 160 may multiplex the binaries and/or libraries of the host OS 115 between multiple containers 114. The container engine 160 may also facilitate interactions between the container 114 and the resources of the computing device 120. For example, the container engine 160 may manage requests from container 114 to access a memory (e.g., a RAM) of the computing device 120. In another example, the container engine 160 may manage requests from the container 114 to access certain libraries/binaries of the host OS 115. In other embodiments, the container engine 160 may also be used to create, remove, and manage containers 114. In one embodiment, the container engine 160 may be a component of the host operating system 115 (e.g., Red Hat Enterprise Linux). In another embodiment, container engine 160 may run on top of a host operating system 115, or may run directly on host hardware without the use of a host operating system 115.

FIGS. 2A and 2B illustrate some of the differences between a VM-based solution (FIG. 2A) and a container-based solution (FIG. 2B). In a VM-based solution an entire virtual system, including a OS kernel and operating system (e.g., guest OS kernel 214) are utilized to execute the application 218. While this can allow for a wide range of support, it increases the overhead to execute the application 218. In contrast, in a container-based solution, the container application 118 executes from a same host OS 115, eliminating the need for a full guest OS installation. Because the container 114 shares the host OS 115, challenges can arise if container application 118 is non-native to the host OS 115. Embodiments of the present invention address these and other challenges.

Referring back to FIG. 1, the container application 118 may execute within the container 114. For example, the container application 118 may execute within a runtime environment provided by the container engine 160. Both the container 114 and the container application 118 may be created by the host OS 115 (e.g., via container engine 160). The host OS 115 may provide administrators and users with the capability to configure and deploy a variety of applications and/or network functions within containers 114.

In some embodiments, the container application 118 may be non-native to the host operating system 115. That is to say that the container application 118 may be compiled and/or otherwise built for a different operating system than the host operating system 115. As a result, container application 118 may be unable to executed on operating system 115 without compatibility support. In some embodiments, the container 114 includes the container application 118 as well as additional support infrastructure. In some embodiments, the support infrastructure may also be incompatible with the host operating system 115. For example, in some embodiments, the entire container 114 may be configured to be compatible with a different operating system than the host OS 115. As an example, the host OS may be Linux-based, and the container 114 may be a Windows-based container 114, in which the container application 118 as well as the underlying support infrastructure of the container 114 are Windows-compatible.

In order to support the non-native container 114, the container engine 160 may provide an emulator 170. The emulator 170 may be configured to provide a compatibility layer between the non-native container/container application 114, 118 and the operating system 115. As previously described, the container 114 and container application 118 may execute within a user space of the computing device 120. The emulator 170 may provide an interface to allow the non-native container application 118 to be executed within the user space despite its incompatibility with the operating system 115. Additional details on the emulator 170 will be provided herein.

Container engine 160 may provide an image-based deployment module for creating containers and may store one or more image files corresponding to the container 114 (also referred to herein as “container images”) for creating container instances. In some embodiments, the container images may be stored in repository server 130 (e.g., after being generated by a developer or vendor). Each container image may include a series of layers, which may be combined into a single image as discussed in further detail herein.

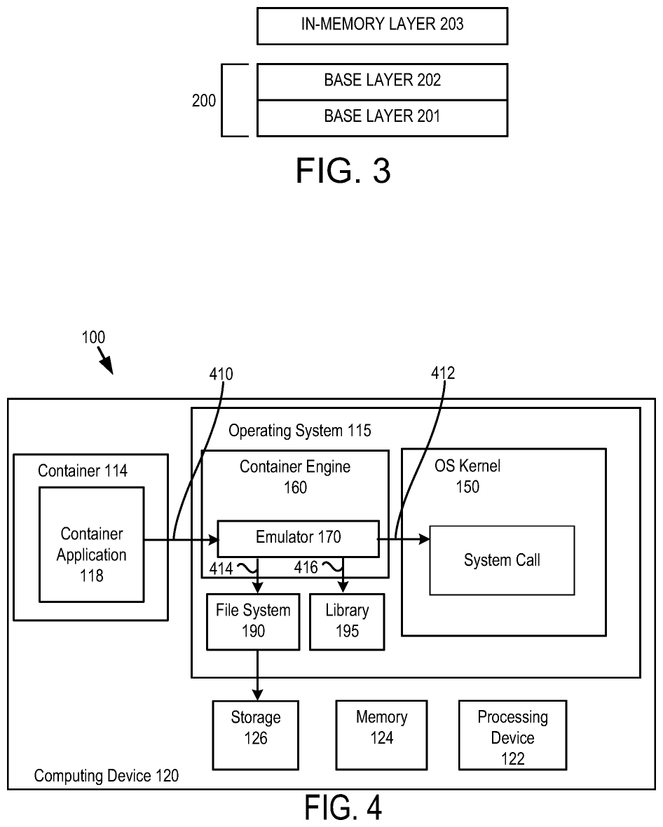

FIG. 3 illustrates an example container image 200 from which the container 114 may be generated. The container image 200 may be stored by the container engine 160 or repository server 130 illustrated in FIG. 1. In some embodiments, as illustrated in FIG. 3, the container image file 200 may include base layers 201 and 202. In some embodiments, the container image 200 may be shared by multiple containers. When the container engine 160 creates a new container 114, it may add a new writable (e.g., in-memory) layer on top of the underlying base layers. This new writable layer is illustrated as the in-memory layer 203 in FIG. 3. When the container 114 is deleted, the in-memory layer 203 is also deleted. However, the underlying container image 200 remains unchanged. Although illustrated as having two base layers for simplicity, container image 200 may include any suitable number of base layers. Base layers may define the runtime environment as well as the packages and utilities necessary for a containerized application (e.g., container application 118 of FIG. 1) to run. In the example of FIG. 3 base layer 201 may comprise the application infrastructure (including e.g., configuration files and/or software packages supporting the container application 118, including any associated libraries, binary and/or source files etc.), on which the container application 118 may run. The base layer 202 may comprise the container application 118 itself. Thus, base layers 201 and 202 may each comprise static snapshots of the configuration of container 114 and may be read-only layers that are not modified. Any changes (e.g., data to be written by the container application 118) may be implemented in subsequent (upper) layers such as in-memory layer 203. Changes made in the in-memory layer 203 may be saved by creating a new layered image.

In some embodiments, both the base layers 201, 202 may be compatible with a particular OS. For example, the base layer 202 may include an application (e.g., container application 118) compatible with a first operating system, and the base layer 201 may contain libraries and packages, also compatible with the first operating system, that may be used to execute the application. According to some embodiments, the container image 200 that is compatible with the first operating system may be executed as a container 114 on a second operating system using the support of an emulator 170 within the container engine 160.

Referring back to FIG. 1, the container 114 may be formed from a container image retrieved from repository server 130 over network 140. For example, the repository server 130 may contain a plurality of container images 114X, 114Y, 114Z. The container images 114X, 114Y, 114Z may include a plurality of different container applications 118 for a plurality of different operating system types. Once selected, the container 114 may be loaded onto the computing device 120 for execution.

The container engine 160 may utilize isolation mechanisms 165 to isolate the container 114 from other processes 112. The isolation mechanisms 165 may include, for example, the use of namespaces and cgroups within the host operating system 115. For example, due to the isolation 165, the container application 118 may be unable to interact with the other processes 112 or access resources of the computing device 120 that are not expressly allocated to the container 114. In this way, the container 114 may be compartmentalized in its execution.

FIG. 4 is a schematic diagram of system 100 that provides additional details regarding the container engine 160, according to some embodiments of the present disclosure. A descriptions of elements of FIG. 4 that have been described with respect to previous figures will be omitted for brevity.

Referring to FIG. 4, the system 100 may include the operating system 115 illustrated in FIG. 1. The operating system 115 may include OS kernel 150 and container engine 160. The system 100 may include executing processes including container 114 (e.g., executed using processing device 122 and memory 124). Container application 118 may execute within container 114 with the assistance of the container engine 160.

The container application 118 may be compatible with an operating system that is different than operating system 115. For example, the container application 118 may be non-native to operating system 115. As an example, the container application 118 may be compatible with Windows while the operating system 115 is a Linux-based operating system 115. In some embodiments, the entire container 114 may be non-native to the operating system 115. For example, the container 114 may include additional infrastructure, libraries, and/or configuration files, each of which may be compatible with an operating system type that is different from the operating system 115.

In some embodiments, the container 114 may be free of an operating system kernel. For example, if the operating system with which the container 114 is compatible is a first operating system and the host operating system 115 is a second operating system, then the container 114 may be free of an OS kernel for the first operating system. Such an implementation differs, for example, with the VM infrastructure discussed herein with respect to FIG. 2A, which may achieve compatibility between OS types by executing an OS kernel (and the accompanying operating system) on virtualized hardware.

In some embodiments, the container engine 160 may provide translation between the host operating system 115 and the operating system with which the container 114 is compatible through the use of the emulator 170. In some embodiments, when a container 114 is selected for execution the container engine 160 launches and configures a runtime environment for the container 114. The runtime environment may provide configurations, executables, and supporting libraries to support execution of the container 114. In some embodiments of the present disclosure, the container runtime environment executed by the container engine 160 may include an instantiation of the emulator 170.

The emulator 170 may intercept non-native accesses made by the container application 118 and translate them to accesses that are compatible with the host operating system 115. For example, in some embodiments, the container application 118 may be configured to make requests 410 of a first operating system (e.g., an operating system with which the container application 118 is compatible). The requests 410 may be made as part of an execution of the container application 118.

The requests 410 may be intercepted by the emulator 170 of the container engine 160. For example, the emulator 170 may be a part of the runtime environment launched by the container engine 160. The emulator 170 may translate the requests 410 into requests that are compatible with the host operating system 115.

For example, in some embodiments, the request 410 may be a system call that would otherwise be compatible with the operating system with which the container application 118 is compatible. The system call of the request 410 may be non-native to the host OS 115 and may thus be incompatible with the host OS 115. For example, the container application 118 may be a Windows-based application and the request 410 may be a Windows-based system call. The emulator 170 may translate such a system call request 410 into a system call 412 that is compatible with a system call provided by the OS kernel 150 of the host OS 115. For example, a Windows-based system call of the container application 118 may be translated into a Linux-based system call. The results of the translated request 412, if present, may be provided back to the container application 118 via the emulator 170.

As another example, in some embodiments, the request 410 may be a storage-based request that would otherwise be compatible with the operating system with which the container application 118 is compatible. The storage-based request 410 may be non-native to the host OS 115 and may thus be incompatible with the host OS 115. For example, the container application 118 may be a Windows-based application and the request 410 may be a request for an object in storage that is compatible with a Windows-based file system. The emulator 170 may translate such a non-native storage-based request 410 into a compatible storage-based request 414 that is compatible with the host OS 115. For example, a Windows-based file system request of the container application 118 may be translated into a request 414 for a file system 190 that is compatible with a Linux-based OS 115. The call to the file system 190 may access storage device 126. The results of the translated request 414, if present, may be provided back to the container application 118 via the emulator 170.

As another example, in some embodiments, the request 410 may be a request to a library that would otherwise be compatible with the operating system with which the container application 118 is compatible. The library request 410 may be non-native to the host OS 115 and may thus be incompatible with the host OS 115. For example, the container application 118 may be a Windows-based application and the request 410 may be a request to a component of a software library that would otherwise be provided by the Windows operating system. The emulator 170 may translate such a non-native library request 410 into a request 416 to a library 195 that provides similar functionality on the Linux-based operating system 115. The results of the translated request 416, if present, may be provided back to the container application 118 via the emulator 170.

The system call, file system, and library examples of FIG. 4 are not intended to be limiting to the embodiments of the present disclosure. It will be understood that other types of requests 410 could be supported by the emulator 170 without deviating from the embodiments of the present disclosure.

In some embodiments, the emulator 170 may be provided in the form of computer-readable software instructions that execute as part of, or launched by, container engine 160. In some embodiments, the emulator 170 may be a computer software package that is loaded as part of the container engine 160, and is configured to execute within the container runtime environment (e.g., to provide an emulation layer). In some embodiments, configuration of the emulator 170 may be maintained by the container engine 160, such that the container 114 is unaware of it (e.g., the emulator 170 is not configured by the container 114 or contained within the container 114). As a non-limiting example, to support a Windows-based container 116, the emulator 170 may contain, in part, the WINE open-source computer software package. As another non-limiting example, to support an android-based container 116, the emulator 170 may contain, in part, the Dalvik open-source computer software package and/or the Android Runtime open-source computer software package.

The container engine 160 may configure the emulator 170 for seamless operation with the container 114. As part of generating the container runtime environment, the emulator 170 may be launched and automatically configured such that the requests of the container application 118 of the container 114 are automatically translated by the emulator 170. In this way, the container 114 may be fully non-native to the operating system 115.

In some embodiments, the emulator 170 may provide a Windows compatibility layer that translates Windows system calls into POSIX-compliant system calls, recreates the directory structure of Windows, and provides alternative implementations of Windows system libraries.

In some embodiments, the container engine 160 may be based on an Open Container Initiative (OCI) infrastructure, and an OCI runtime environment may be utilized to instantiate the container 114 into existence. In some embodiments, the OCI runtime environment may provide an execution phase for the container 114 where the OCI runtime environment communicates with the OS kernel 150 to start containerized processes (e.g., using Linux native system calls).

Embodiments according to the present disclosure may leverage an existing OCI runtime infrastructure and enhance it in such a way that if configured to run a Windows-based workload, the OCI runtime infrastructure can invoke a Windows compatibility layer (e.g., as emulator 170) with “workload specified in container as an input” instead of allowing the workload to be executed directly in a Linux environment. So before the workload actually starts executing, the configured windows compatibility layer (e.g., as emulator 170) will intercept and convert all existing Windows system calls from the container application 118 and container 114 into POSIX-compliant system calls. One example of an existing OCI runtime environment that may be run in conjunction with the container engine 160 includes the open source software package crun. However, embodiments of the present disclosure are not limited to this software package.

In some embodiments, the emulator 170 (e.g., WINE) may be statically integrated into the container engine 160 (e.g., crun) to that a Windows compatibility layer may be used as a static C library. As an example only, embodiments of the present disclosure may be provided as a set of software instructions containing a function/method int libcrun_windows_compatiblity_layer(runtime* winehq, const char *path); In the above example, ‘runtime’ is a pseudo datatype for an interface or structure which may contain a function that can ingest path to a windows-specific workload and perform execution of POSIX-compliant system calls over a compartmentalized Linux environment created by the OCI runtime environment crun. In such an embodiment, POSIX-compliant system calls may be generated and executed by core functions of the emulator 170 (e.g., WineHQ) inside a compartmentalized Linux environment created by the OCI runtime crun.

The embodiments described herein, when implemented and stacked together may provide an illusion to the user as if the specified container 114 containing a windows workload (or other non-native workload) is actually being executed on a compatible host device (e.g., a Windows-based device) without requiring the full overhead of a VM implementation. This may provide the ability to share a common Linux-based infrastructure for running both Windows- and Linux-compatible containers (or other non-native operating system).

This configuration provides a number of benefits. As an example, the container 114 may be agnostic as to the operating system 115 upon which it is to run. The details of the translation to the native host operating system 115 are handled by the emulator 170 and the container engine 160, which can make the decisions specific to the operating system 115. This may be contrasted with a container in which the translation/emulation is provided as part of the container itself. In such an example, a separate container may be generated for each host operating system that is to be supported. By separating the translation from the container 114, greater customization, including security and performance, may be provided by the administrator of the computer system 100.

In addition, as previously described, by maintaining the non-native container application 118 in a container 114, its execution may be compartmentalized. As the access available to the container 114 may be strictly controlled, the execution environment of the container application 118 may be limited, and the container application 118 may be kept from interacting with other processes on the computing device 120. Thus, embodiments according to the present disclosure may provide greater flexibility, increased performance, and more secure executing environments.

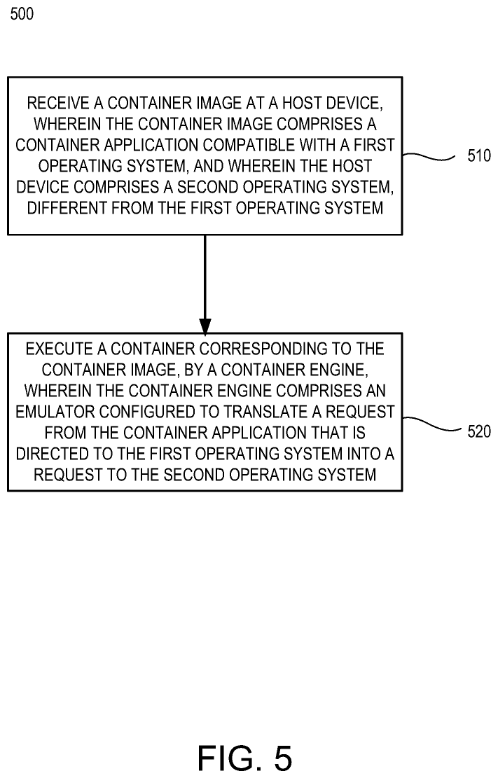

FIG. 5 is a flow diagram of a method 500 for executing a non-native container image, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by a computing device (e.g., computing device 120 illustrated in FIGS. 1 and 4).

Referring simultaneously to FIG. 4 as well, the method 500 begins at block 510, in which a container image 114 may be received as a host device 120. The container image 114 may include a container application 118 compatible with a first operating system. The host computing device 120 may include a second operating system that is different from the first operating system. In some embodiments, the container image 114 may be retrieved from repository server 130. In some embodiments, the container image 114 is free of an executable that is compatible with the second operating system. In some embodiments, the host computing device 120 and the container image 114 are free of a kernel of the first operating system. In some embodiments, the second operating system is a Linux-based operating system, and wherein the first operating system is a non-Linux-based operating system.

At block 515, a container engine 160 is to execute a container corresponding to the container image (e.g., on a processing device 122). The container engine 160 includes an emulator 170 configured to translate a request 410 from the container application 118 that is directed to the first operating system into a request to the second operating system. The container engine 160 is configured to isolate the container 114 corresponding to the container image 114 from other applications of the host computing device 120 that are compatible with the second operating system. In some embodiments, the request 410 from the container application 118 that is to the first operating system is a system call directed to the first operating system, and the emulator 170 is configured to translate the system call directed to the first operating system into a system call 412 directed to the second operating system executing on the host computing device 120.

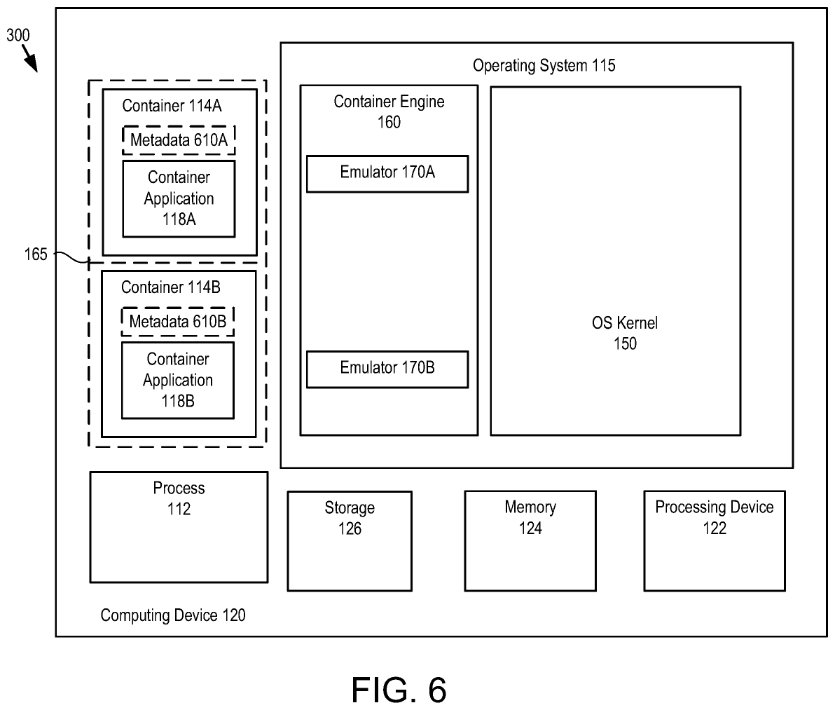

FIG. 6 is a block diagram that illustrates an example system 300, according to some embodiments of the present disclosure. A descriptions of elements of FIG. 6 that have been described with respect to previous figures will be omitted for brevity.

Referring to FIG. 6, the system 300 may include the operating system 115 illustrated in FIG. 1. The operating system 115 may include OS kernel 150 and container engine 160. The operating system 115, OS kernel 150, and container engine 160 may operate substantially similarly as previously described.

The system 300 may include executing processes including a first container 114A, a second container 114B, and process(es) 112. A first container application 118A may execute within the first container 114A with the assistance of the container engine 160. A second container application 118B may execute within the second container 114B with the assistance of the container engine 160.

The first container application 118A and the second container application 118B may be compatible with an operating system that is different than operating system 115. Moreover, the first container application 118A may be compatible with an operating system that is different than the operating system with which the second container application 118B is compatible. For example, the first container application 118A may be non-native to both operating system 115 and the second container application 118B, and the second container application 118B may be non-native to both operating system 115 and the first container application 118A. As an example, the first container application 118A may be compatible with Windows, the second container application 118B may be compatible with Android, and the operating system 115 may be a Linux-based operating system 115 (e.g., Red Hat Enterprise Linux). In some embodiments, the entire first and second containers 114A, 114B may be non-native to the operating system 115.

In some embodiments, the first container 114A and the second container 114B may be free of an operating system kernel. For example, if the host operating system 115 is a first operating system, and the operating systems with which the first and second containers 114A, 114B are compatible are second and third operating systems, respectively, then the first container 114A may be free of an OS kernel for the second operating system and the second container 114B may be free of an OS kernel for the third operating system. Such an implementation differs, for example, with the VM infrastructure discussed herein with respect to FIG. 2A, which may achieve compatibility between OS types by executing an OS kernel (and the accompanying operating system) on virtualized hardware.

In some embodiments, the container engine 160 may provide translation between the host operating system 115 and the operating systems with which the first and second containers 114A, 114B are compatible through the use of first and second emulators 170A, 170B. The first emulator 170A may be different from the second emulator 170B.

For example, upon loading the first container 114A, the container engine 160 may query metadata 610A of the first container 114A. The metadata 610A may include a type of the operating system of the first container 114A (e.g., an operating system with which the contents of the first container 114A, including the firs container application 118A, are compatible). For example, if the first container application 118A is compatible and/or native to Windows, the metadata 610A of the first container 114A may indicate the type of the first container 114A as a windows type. For example, if the second container application 118B is compatible and/or native to Android, the metadata 610B of the second container 114B may indicate the type of the second container 114B as an android type. Though metadata 610 is utilized in FIG. 6 as a mechanism to determine the type of the container 114, the embodiments of the present disclosure are not limited thereto. In some embodiments, the metadata 610 is optional, and the container engine 160 may analyze the contents of the container 114 to determine the container type. For example, the container engine 160 may analyze the structure and/or content of the executable associated with the container application 118, or may analyze the structure and/or content of the configuration files of the container 114, to determine the type of the container 114.

Based on type of the container 114 (e.g., as indicated by the metadata 610), the container engine 160 may select an emulator 170 that is compatible with the container 114. For example, the container engine 160 may select a first emulator 170A for the first container 114A based on the type of the first container 114A. The first emulator 170A may selected to be compatible with the first container 114A and to translate requests from the first container 114A to the operating system 115 with which the first container application 118A of the first container 114A is non-native. Similarly, the container engine 160 may select a second emulator 170B for the second container 114B based on the type of the second container 114B. The second emulator 170B may selected to be compatible with the second container 114B and to translate requests from the second container 114B to the operating system 115 with which the second container application 118B of the second container 114B is non-native. The first and second emulators 170A, 170B may operate similarly to the emulator 170 discussed herein with respect to FIGS. 1 and 4 and, thus, a duplicate description thereof will be omitted.

In some embodiments, the first and second emulators 170A, 170B may be stored locally to the system 300, but the embodiments of the present disclosure are not limited thereto. In some embodiments, the first and second emulators 170A, 170B may be dynamically retrieved (e.g., from repository server 130 of FIG. 1 or from other storage, either local or remote) based on the determined type of the containers 114.

As discussed previously with respect to FIG. 1, the first and second containers 114A, 114B may be isolated from other processes 112 on the system 300 by isolation mechanisms 165. Moreover, the first container 114A may be isolated from the second container 114B. The isolation mechanisms 165 may provide increased security and compartmentalization between the executing containers 114.

The system 300 of FIG. 6 provides the ability to dynamically execute multiple containers 114 of different operating system types. In addition, the multiple containers 114 may support different operating systems and be isolated from one another during execution. The system 300 provides technological improvement to conventional devices in that it extends the support for containers 114 beyond the operating system 115 of the host computing device 120, but also improves the flexibility, performance, and security of the system 300.

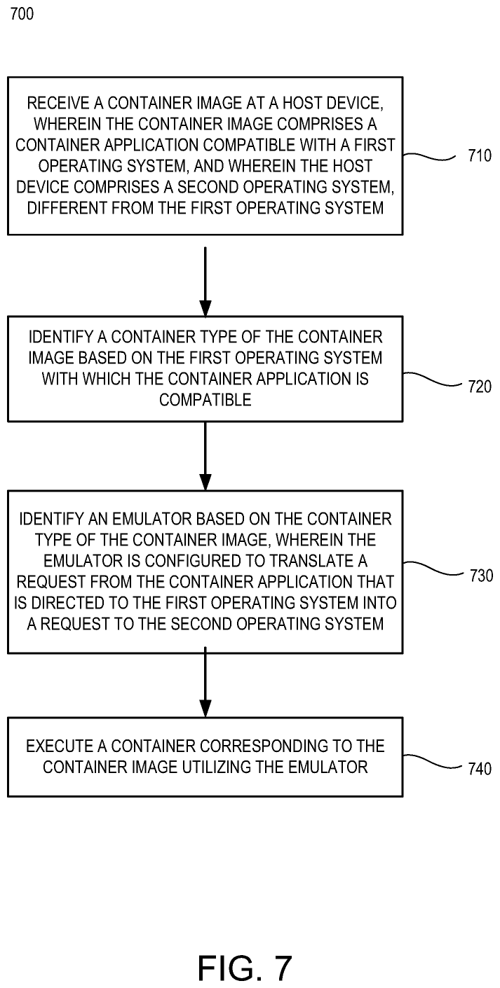

FIG. 7 is a flow diagram of a method 700 for dynamically executing a non-native container image, in accordance with some embodiments of the present disclosure. Method 700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof In some embodiments, the method 700 may be performed by a computing device (e.g., computing device 120 illustrated in FIGS. 1, 4, and 6).

Referring simultaneously to FIGS. 4 and 6 as well, the method 700 begins at block 710, in which a container image 114 may be received at a host computing device 120. The container image 114 may include a container application 118 compatible with a first operating system. The host computing device 120 may include a second operating system 115 that is different from the first operating system. In some embodiments, the container image 114 may be retrieved from repository server 130. In some embodiments, the container image 114 is free of an executable that is compatible with the second operating system. In some embodiments, the host computing device 120 and the container image 114 are free of a kernel of the first operating system. In some embodiments, the second operating system is a Linux-based operating system, and wherein the first operating system is a non-Linux-based operating system.

At block 720, a container type of the container image is identified based on the first operating system with which the container application 118 is compatible. In some embodiments, the container type of the container image may be identified based on metadata 610 of the container image.

At block 730, an emulator 170 is identified based on the container type of the container image. The emulator 170 may be configured to translate a request 410 from the container application 118 that is directed to the first operating system into a request to the second operating system 115.

At block 740, the container application 118 of the container 114 corresponding to the container image is executed utilizing the emulator 170. In some embodiments, the emulator 170 is provided by a container engine 160. The container engine 160 may be configured to isolate the container 114 corresponding to the container image 114 from other applications of the host computing device 120 that are compatible with the second operating system. In some embodiments, the request 410 from the container application 118 that is to the first operating system is a system call directed to the first operating system, and the emulator 170 is configured to translate the system call directed to the first operating system into a system call 412 directed to the second operating system 115 executing on the host computing device 120.

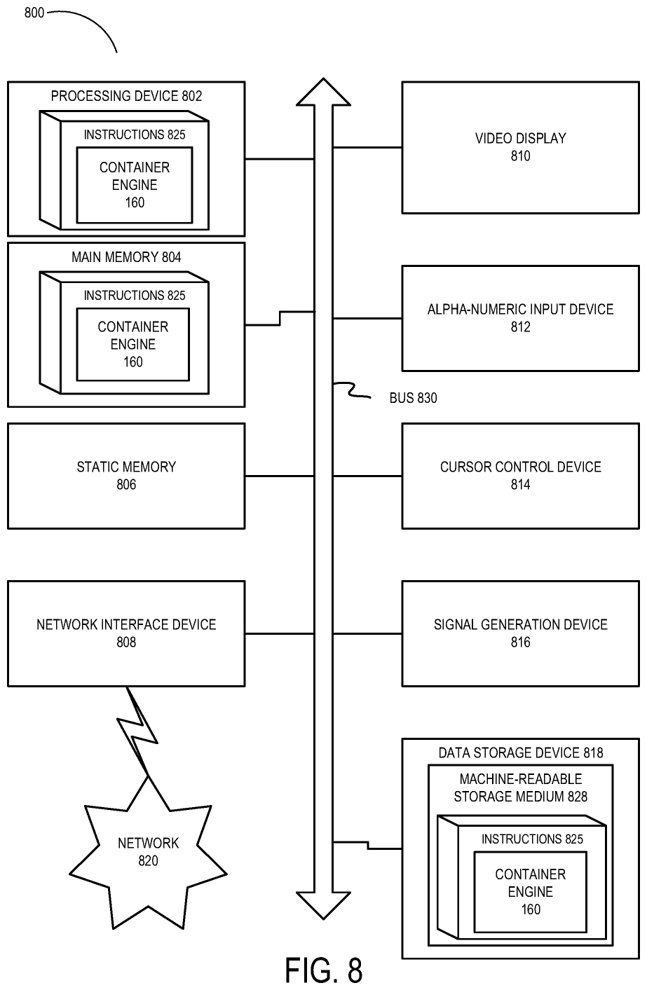

FIG. 8 is a block diagram of an example computing device 800 that may perform one or more of the operations described herein, in accordance with some embodiments of the disclosure. Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device (e.g., a general purpose processor, a PLD, etc.) 802, a main memory 804 (e.g., synchronous dynamic random access memory (DRAM), read-only memory (ROM)), a static memory 806 (e.g., flash memory and a data storage device 818), which may communicate with each other via a bus 830.

Processing device 802 may be provided by one or more general-purpose processing devices such as a microprocessor, central processing unit, or the like. In an illustrative example, processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also include one or more special-purpose processing devices such as an application specific integrated circuit (ASIC), a field programmable gate array (FPGA), a digital signal processor (DSP), network processor, or the like. The processing device 802 may execute the operations described herein, in accordance with one or more aspects of the present disclosure, for performing the operations and steps discussed herein.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 828 on which may be stored one or more sets of instructions 825 that may include instructions for a container engine, e.g., container engine 160 (e.g., including emulator 170) for carrying out the operations described herein, in accordance with one or more aspects of the present disclosure. Instructions 825 may also reside, completely or at least partially, within main memory 804 and/or within processing device 802 during execution thereof by computing device 800, main memory 804 and processing device 802 also constituting computer-readable media. The instructions 825 may further be transmitted or received over a network 820 via network interface device 808.

While computer-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Example 1 is a method comprising: receiving a container image at a host device, wherein the container image comprises a container application compatible with a first operating system, and wherein the host device comprises a second operating system, different from the first operating system; and executing a container corresponding to the container image, by a container engine on a processing device, wherein the container engine comprises an emulator configured to translate a request from the container application that is directed to the first operating system into a request to the second operating system.

Example 2 is the method of Example 1, wherein the container image is free of an executable that is compatible with the second operating system.

Example 3 is the method of any of Examples 1-2, wherein the container engine is configured to isolate the container corresponding to the container image from other applications of the host device that are compatible with the second operating system.

Example 4 is the method of any of Examples 1-3, wherein the host device and the container image are free of a kernel of the first operating system.

Example 5 is the method of any of Examples 1-4, wherein the second operating system is a Linux-based operating system, and wherein the first operating system is a non-Linux-based operating system.

Example 6 is the method of any of Examples 1-5, wherein the request from the container application that is to the first operating system is a system call directed to the first operating system, and wherein the emulator is configured to translate the system call directed to the first operating system into a system call directed to the second operating system executing on the host device.

Example 7 is the method of any of Examples 1-6, further comprising: determining a container type of the container image; and selecting the emulator based on the container type.

Example 8 is the method of any of Examples 1-7, wherein the request from the container application that is to the first operating system is a storage-based request directed to a first file system of the first operating system, and wherein the emulator is configured to translate the storage-based request directed to the first file system into a request directed to a second file system of the second operating system executing on the host device.

Example 9 is the method of any of Examples 1-8, wherein the request from the container application that is to the first operating system is a library request directed to a first library that is compatible with the first operating system, and wherein the emulator is configured to translate the library request directed to the first library into a request directed to a second library of the second operating system executing on the host device.

Example 10 is a system comprising: a memory; and a processing device operatively coupled to the memory, to: receive a container image at a host device, wherein the container image comprises a container application compatible with a first operating system, and wherein the host device comprises a second operating system, different from the first operating system; and execute a container corresponding to the container image, by a container engine, wherein the container engine comprises an emulator configured to translate a request from the container application that is directed to the first operating system into a request to the second operating system.

Example 11 is the system of Example 10, wherein the container image is free of an executable that is compatible with the second operating system.

Example 12 is the system of any of Examples 10-11, wherein the container engine is configured to isolate the container corresponding to the container image from other applications of the host device that are compatible with the second operating system.

Example 13 is the system of any of Examples 10-12, wherein the host device and the container image are free of a kernel of the first operating system.

Example 14 is the system of any of Examples 10-13, wherein the second operating system is a Linux-based operating system, and wherein the first operating system is a non-Linux-based operating system.

Example 15 is the system of any of Examples 10-14, wherein the request from the container application that is to the first operating system is a system call directed to the first operating system, and wherein the emulator is configured to translate the system call directed to the first operating system into a system call directed to the second operating system executing on the host device.

Example 16 is the system of any of Examples 10-15, wherein the processing device is further to: determine a container type of the container image; and select the emulator based on the container type.

Example 17 is the system of any of Examples 10-16, wherein the request from the container application that is to the first operating system is a storage-based request directed to a first file system of the first operating system, and wherein the emulator is configured to translate the storage-based request directed to the first file system into a request directed to a second file system of the second operating system executing on the host device.

Example 18 is the system of any of Examples 10-17, wherein the request from the container application that is to the first operating system is a library request directed to a first library that is compatible with the first operating system, and wherein the emulator is configured to translate the library request directed to the first library into a request directed to a second library of the second operating system executing on the host device.

Example 19 is a non-transitory computer-readable storage medium including instructions that, when executed by a processing device, cause the processing device to: receive a container image at a host device, wherein the container image comprises a container application compatible with a first operating system, and wherein the host device comprises a second operating system, different from the first operating system; and execute a container corresponding to the container image, by a container engine, wherein the container engine comprises an emulator configured to translate a request from the container application that is directed to the first operating system into a request to the second operating system.

Example 20 is the non-transitory computer-readable storage medium of Example 19, wherein the container image is free of an executable that is compatible with the second operating system.

Example 21 is the non-transitory computer-readable storage medium of any of Examples 19-20, wherein the container engine is configured to isolate the container corresponding to the container image from other applications of the host device that are compatible with the second operating system.

Example 22 is the non-transitory computer-readable storage medium of any of Examples 19-21, wherein the host device and the container image are free of a kernel of the first operating system.

Example 23 is the non-transitory computer-readable storage medium of any of Examples 19-22, wherein the second operating system is a Linux-based operating system, and wherein the first operating system is a non-Linux-based operating system.

Example 24 is the non-transitory computer-readable storage medium of any of Examples 19-23, wherein the request from the container application that is to the first operating system is a system call directed to the first operating system, and wherein the emulator is configured to translate the system call directed to the first operating system into a system call directed to the second operating system executing on the host device.

Example 25 is the non-transitory computer-readable storage medium of any of Examples 19-24, wherein the processing device is further to: determine a container type of the container image; and select the emulator based on the container type.

Example 26 is the non-transitory computer-readable storage medium of any of Examples 19-25, wherein the request from the container application that is to the first operating system is a storage-based request directed to a first file system of the first operating system, and wherein the emulator is configured to translate the storage-based request directed to the first file system into a request directed to a second file system of the second operating system executing on the host device.

Example 27 is the non-transitory computer-readable storage medium of any of Examples 19-26, wherein the request from the container application that is to the first operating system is a library request directed to a first library that is compatible with the first operating system, and wherein the emulator is configured to translate the library request directed to the first library into a request directed to a second library of the second operating system executing on the host device.

Example 28 is a system comprising: a memory; and a processing device operatively coupled to the memory, to: receive a container image at a host device, wherein the container image comprises a container application compatible with a first operating system, and wherein the host device comprises a second operating system, different from the first operating system; identify a container type of the container image based on the first operating system with which the container application is compatible; identify an emulator based on the container type of the container image, wherein the emulator is configured to translate a request from the container application that is directed to the first operating system into a request to the second operating system; and execute a container corresponding to the container image utilizing the emulator.

Example 29 is the system of Example 28, wherein the container type of the container image may be identified based on metadata of the container image.

Example 30 is the system of any of Examples 28-29, wherein the container image is free of an executable that is compatible with the second operating system.

Example 31 is the system of any of Examples 28-30, wherein the container engine is configured to isolate the container corresponding to the container image from other applications of the host device that are compatible with the second operating system.

Example 32 is the system of any of Examples 28-31, wherein the host device and the container image are free of a kernel of the first operating system.

Example 33 is the system of any of Examples 28-32, wherein the second operating system is a Linux-based operating system, and wherein the first operating system is a non-Linux-based operating system.

Example 34 is the system of any of Examples 28-33, wherein the request from the container application that is to the first operating system is a system call directed to the first operating system, and wherein the emulator is configured to translate the system call directed to the first operating system into a system call directed to the second operating system executing on the host device.

Example 35 is the system of any of Examples 28-34, wherein the processing device is further to: determine a container type of the container image; and select the emulator based on the container type.

Example 36 is the system of any of Examples 28-35, wherein the request from the container application that is to the first operating system is a storage-based request directed to a first file system of the first operating system, and wherein the emulator is configured to translate the storage-based request directed to the first file system into a request directed to a second file system of the second operating system executing on the host device.

Example 37 is the system of any of Examples 28-36, wherein the request from the container application that is to the first operating system is a library request directed to a first library that is compatible with the first operating system, and wherein the emulator is configured to translate the library request directed to the first library into a request directed to a second library of the second operating system executing on the host device.

Example 38 is the system of any of Examples 28-37, wherein the container image is a first container image, the container application is a first container application, the container type is a first container type, the container is a first container, and the emulator is a first emulator, and wherein the processing devices is further to: receive a second container image at the host device, wherein the second container image comprises a second container application compatible with a third operating system that is different from the first operating system and the second operating system; identify a second container type of the second container image based on the third operating system with which the second container application is compatible; identify a second emulator based on the second container type of the second container image, wherein the second emulator is configured to translate a request from the second container application that is directed to the third operating system into a request to the second operating system; and execute a second container corresponding to the second container image utilizing the second emulator.

Example 39 is an apparatus comprising: means for receiving a container image, wherein the container image comprises a container application compatible with a first operating system, and wherein the host device comprises a second operating system, different from the first operating system; and means for executing a container corresponding to the container image utilizing an emulator configured to translate a request from the container application that is directed to the first operating system into a request to the second operating system.

Example 40 is the apparatus of Example 39, wherein the container image is free of an executable that is compatible with the second operating system.

Example 41 is the apparatus of any of Examples 39-40, further comprising means for isolating the container corresponding to the container image from other applications that are compatible with the second operating system.

Example 42 is the apparatus of any of Examples 39-41, wherein the container image is free of a kernel of the first operating system.

Example 43 is the apparatus of any of Examples 39-42, wherein the second operating system is a Linux-based operating system, and wherein the first operating system is a non-Linux-based operating system.

Example 44 is the apparatus of any of Examples 39-43, wherein the request from the container application that is to the first operating system is a system call directed to the first operating system, and wherein the emulator is configured to translate the system call directed to the first operating system into a system call directed to the second operating system executing on the host device.

Example 45 is the apparatus of any of Examples 39-44, further comprising: means for determining a container type of the container image; and means for selecting the emulator based on the container type.

Example 46 is the apparatus of any of Examples 39-45, wherein the request from the container application that is to the first operating system is a storage-based request directed to a first file system of the first operating system, and wherein the emulator is configured to translate the storage-based request directed to the first file system into a request directed to a second file system of the second operating system.

Example 46 is the apparatus of any of Examples 39-46, wherein the request from the container application that is to the first operating system is a library request directed to a first library that is compatible with the first operating system, and wherein the emulator is configured to translate the library request directed to the first library into a request directed to a second library of the second operating system.

Unless specifically stated otherwise, terms such as “receiving,” “executing,” “determining,” “identifying,” “selecting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a container image at a host device, wherein the container image comprises a container application compatible with a first operating system, and wherein the host device comprises a second operating system, different from the first operating system; and
executing a container corresponding to the container image, by a container engine on a processing device, wherein the container engine comprises an emulator configured to translate a request from the container application that is directed to the first operating system into a request to the second operating system.

2. The method of claim 1, wherein the container image is free of an executable that is compatible with the second operating system.

3. The method of claim 1, wherein the container engine is configured to isolate the container corresponding to the container image from other applications of the host device that are compatible with the second operating system.

4. The method of claim 1, wherein the host device and the container image are free of a kernel of the first operating system.

5. The method of claim 1, wherein the second operating system is a Linux-based operating system, and wherein the first operating system is a non-Linux-based operating system.

6. The method of claim 1, wherein the request from the container application that is to the first operating system is a system call directed to the first operating system, and
wherein the emulator is configured to translate the system call directed to the first operating system into a system call directed to the second operating system executing on the host device.

7. The method of claim 1, further comprising:
determining a container type of the container image; and
selecting the emulator based on the container type.

8. A system comprising:
a memory; and
a processing device, operatively coupled to the memory, to:
receive a container image at a host device, wherein the container image comprises a container application compatible with a first operating system, and wherein the host device comprises a second operating system, different from the first operating system; and
execute a container corresponding to the container image, by a container engine, wherein the container engine comprises an emulator configured to translate a request from the container application that is directed to the first operating system into a request to the second operating system.

9. The system of claim 8, wherein the container image is free of an executable that is compatible with the second operating system.

10. The system of claim 8, wherein the container engine is configured to isolate the container corresponding to the container image from other applications of the host device that are compatible with the second operating system.

11. The system of claim 8, wherein the host device and the container image are free of a kernel of the first operating system.

12. The system of claim 8, wherein the second operating system is a Linux-based operating system, and wherein the first operating system is a non-Linux-based operating system.

13. The system of claim 8, wherein the request from the container application that is to the first operating system is a system call directed to the first operating system, and
wherein the emulator is configured to translate the system call directed to the first operating system into a system call directed to the second operating system executing on the host device.

14. The system of claim 8, wherein the processing device is further to:
determine a container type of the container image; and
select the emulator based on the container type.

15. A non-transitory computer-readable storage medium including instructions that, when executed by a processing device, cause the processing device to:
receive a container image at a host device, wherein the container image comprises a container application compatible with a first operating system, and wherein the host device comprises a second operating system, different from the first operating system; and
execute a container corresponding to the container image, by a container engine on the processing device, wherein the container engine comprises an emulator configured to translate a request from the container application that is directed to the first operating system into a request to the second operating system.

16. The non-transitory computer-readable storage medium of claim 15, wherein the container image is free of an executable that is compatible with the second operating system.

17. The non-transitory computer-readable storage medium of claim 15, wherein the host device and the container image are free of a kernel of the first operating system.

18. The non-transitory computer-readable storage medium of claim 15, wherein the second operating system is a Linux-based operating system, and wherein the first operating system is a non-Linux-based operating system.

19. The non-transitory computer-readable storage medium of claim 15, wherein the request from the container application that is to the first operating system is a system call directed to the first operating system, and
wherein the emulator is configured to translate the system call directed to the first operating system into a system call directed to the second operating system executing on the host device.

20. The non-transitory computer-readable storage medium of claim 15, wherein the processing device is further to:
determine a container type of the container image; and
select the emulator based on the container type.
